(19) United States
(12) Patent Application Publication
(10) Pub. No.: US 2023/0292953 A1
(43) Pub. Date: Sep. 21, 2023

(54) PIZZA WARMING SERVE TRAY DEVICE

(71) Applicant: First Princeton Asset Management, LLC, New Hope, PA (US)

(72) Inventors: Adolf HERST, New Hope, PA (US); Nicholas OBLAS, Philadelphia, PA (US)

(73) Assignee: First Princeton Asset Management, LLC, New Hope, PA (US)

(21) Appl. No.: 18/082,830

(22) Filed: Dec. 16, 2022

Related U.S. Application Data
(63) Continuation of application No. 16/570,512, filed on Sep. 13, 2019, now abandoned.
(60) Provisional application No. 62/730,845, filed on Sep. 13, 2018.

(51) Int. Cl. A47J 36/24; A47J 36/02; A23L 5/10; H05B 6/12; A47J 47/14

(52) U.S. Cl. CPC A47J 36/2483; A47J 36/025; A23L 5/15; H05B 6/12; A47J 47/145; A23V 2002/00; H05B 2213/07

(57) ABSTRACT

The present disclosure relates to a pizza warming serve tray device for increasing the length of time a pizza stays at an optimal temperature for consumption. In an exemplary embodiment, the device of the present invention comprises a pan and an induction base heating unit, wherein the material of the pan is a bonded metal alloy, and wherein the pan is coated with a molded, food-grade silicone to insulate the heat contained within the pan. The device of the present invention drastically increases the total length of time a pizza remains in the optimal temperature range.

### CROSS REFERENCE TO RELATED APPLICATION

This application is a continuation of U.S. patent application Ser. No. 16/570,512, filed Sep. 13, 2019, and claims priority to U.S. Provisional Application No. 62/730,845, filed Sep. 13, 2018, the disclosures of which are incorporated herein by reference.

### FIELD OF THE DISCLOSURE

This disclosure generally relates to a pizza warming serve tray device. More particularly, the disclosure relates to a pizza warming device comprising a pan and an induction base heating unit for retaining the temperature of pizza and extending the length of time the pizza stays at an optimum temperature for consumption.

### BACKGROUND

Pizza is a common meal, enjoyed by individuals for years. Generally, when a pizza is finished cooking, it is placed on a conventional serving tray or pan and brought to a table at a restaurant where individuals will begin to eat the pizza. However, as soon as the pizza leaves the oven, the temperature of the pizza begins to drop at a rapid rate. Because the temperature of the pizza is significantly greater than the temperature of the tray, once the pizza is placed on the serving pan, heat is transferred between the pizza and the pan. Conventional pans do nothing to retain the temperature of the pizza. As such, after a period of time, the pizza is no longer hot, making it less desirable to eat. The decrease in temperature leads to a decrease in the quality of the pizza and its overall enjoyment by individuals. Thus, there is a need for a device that allows a pizza to retain its temperature by extending the length of time the pizza stays at an optimum eating temperature and thereby maintaining the quality of the pizza for consumers.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

Conventional pizza pans commonly used in restaurants do nothing to maintain the ideal temperature of pizza for consumption and thus result in a short cooling time for pizza. Cooling time refers to the length of time food remains at an optimum temperature range before decreasing to a temperature at which point consumption is no longer desirable. Thus, the object of the invention is to provide a device that increases the pizza's cooling time, i.e. the length of time the pizza stays at an optimum temperature. Another object of the invention is to provide pizza pans that also promote manufacturability and that are not costly.

Another object of the invention is to provide a device comprising a pan of an ideal pan material chosen to significantly reduce weight while increasing thermal performance and induction heating compatibility.

Another object of the invention is to provide a device that increases the length of time pizza is maintained within the ideal temperature range.

Particular embodiments of the present invention are directed to devices for increasing the length of time the pizza is maintained at an optimum temperature for consumption.

In some embodiments, the device may comprise a pan and an induction base heating unit, wherein the material of the pan is a bonded metal alloy, and wherein the pan is coated with a molded, food-grade silicone to insulate the heat contained within the pan. The induction base heating unit may comprise an interface comprising indicator lights, wherein the indicator lights are red, yellow and green. When the indicator light is red, there is no pan on the induction base heating unit. When the indicator light is yellow, the pan is on the induction base heating unit and the induction base heating unit is heating the pan. When the indicator light is green, the pan on the induction base heating unit has reached the optimal temperature range.

In some embodiments, the induction base heating unit heats the pan to a temperature range of 190-220° F.

Further variations encompassed within the devices are described in the detailed description of the invention below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and form part of the specification, illustrate various, non-limiting embodiments of the present invention. In the drawings, like reference numbers indicate identical or functionally similar elements.

FIG. 1 depicts a plan view of an exemplary embodiment of a pan for the pizza warming serve tray device.

FIG. 2 depicts a top view of an exemplary embodiment of a pan for the pizza warming serve tray device.

FIG. 3 depicts a side view of an exemplary embodiment of a pan for the pizza warming serve tray device.

FIG. 4 depicts a bottom view of an exemplary embodiment of a pan for the pizza warming serve tray device.

FIG. 5 depicts an exemplary embodiment of an induction base heating unit for the pizza warming serve tray device.

FIG. 6 depicts an exemplary embodiment of the pizza warming serve tray device comprising a pan and an induction base heating unit.

FIG. 7 depicts a side view of an exemplary embodiment of the pizza warming serve tray device comprising a pan and an induction base heating unit in operating mode.

FIG. 8 depicts a top view of an exemplary embodiment of the pizza warming serve tray device comprising a pan and an induction base heating unit in operating mode.

FIG. 9 depicts a bottom view of an exemplary embodiment of the pizza warming serve tray device comprising a pan and an induction base heating unit in operating mode.

FIG. 10 depicts a front view of an exemplary embodiment of the pizza warming serve tray device comprising a pan and an induction base heating unit in operating mode.

FIG. 11 depicts a diametric view of an exemplary embodiment of the pizza warming serve tray device comprising a pan and an induction base heating unit in operating mode.

FIG. 12 depicts an isometric view of an exemplary embodiment of a rack for holding multiple pans of the pizza warming serve tray device.

FIG. 13 depicts a side view of an exemplary embodiment of a rack for holding multiple pans of the pizza warming serve tray device.

FIG. 14 depicts a top view of an exemplary embodiment of a rack for holding multiple pans of the pizza warming serve tray device.

FIG. 15 depicts a temperature profile of an exemplary embodiment of a pan of the pizza warming serve tray device at different phases during heating for 60 seconds.

FIG. 16 depicts a temperature distribution of an exemplary embodiment of a pan of the pizza warming serve tray device 60 seconds after the pan reached a temperature of 220° F.

FIG. 17 depicts a graph illustrating the experimental results of testing conducted on an exemplary embodiment of the pizza warming serve tray device to determine the total cooling time of the pizza warming serve tray device.

### DETAILED DESCRIPTION

The key factors that determine the length of time a pizza remains in the optimal temperature range for consumption are the initial pan temperature and the thermal mass of the pan. Thermal mass is controlled by the size and type of material. The initial temperature could be set and maintained with induction heating.

The initial temperature of the pan controls the total amount of heat added to the pan and therefore the total amount of heat that may be supplied to the pizza. The temperature supplied to the pan by the induction base heating unit cannot exceed the temperature of the pizza as it exits the oven otherwise the pan will continue to cook the pizza causing a change in the taste. Thus, the ideal temperature range of the pan is critical. Tests conducted revealed that the average pizza crust temperature is 190-200° F. and the ideal starting temperature to maximize the amount of time it takes for the pizza to cool is 220° F.

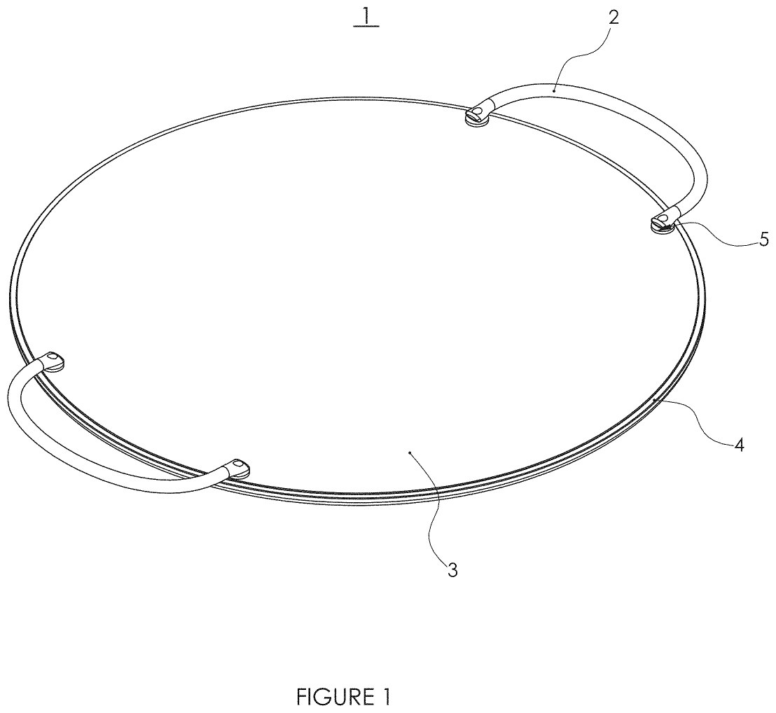

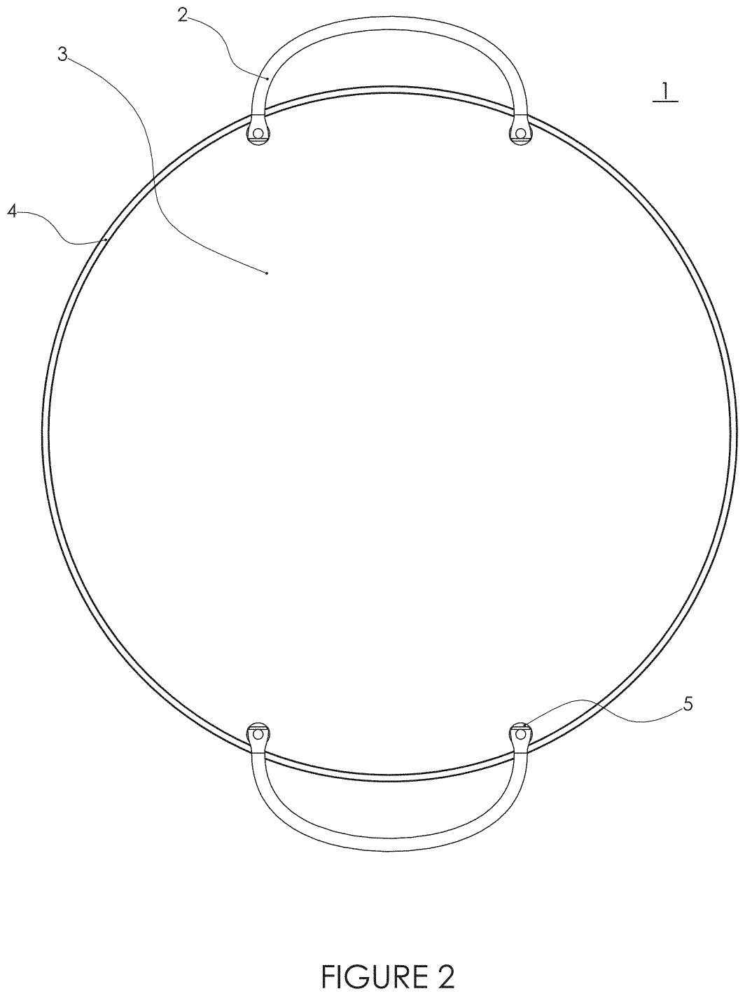

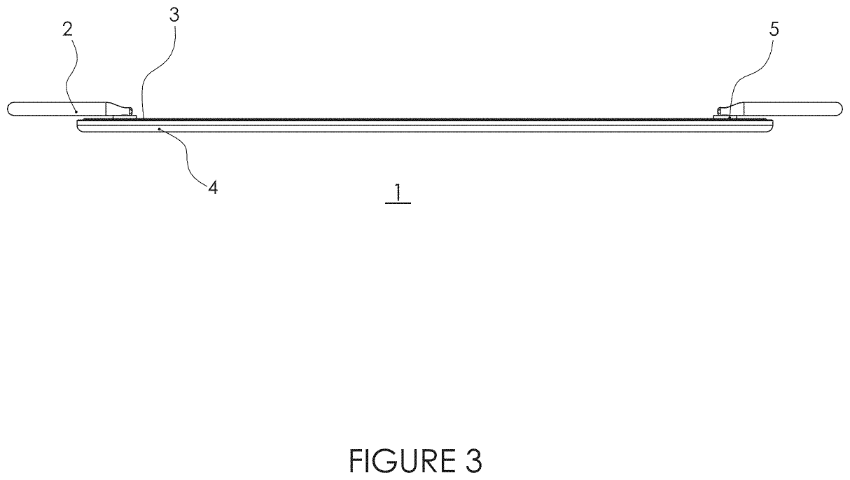

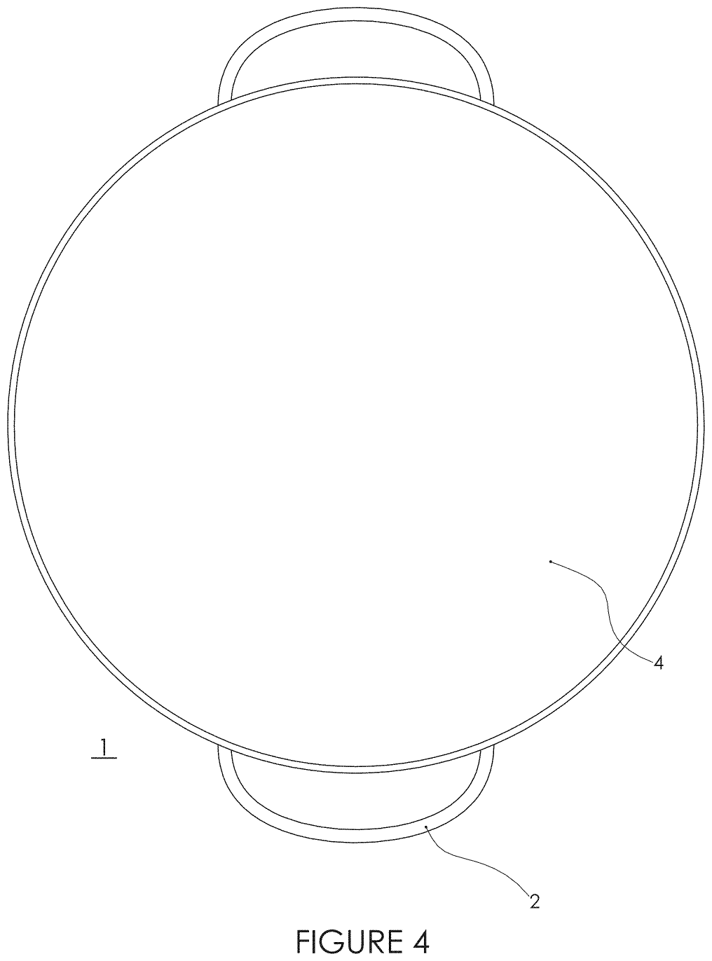

FIGS. 1-4 illustrate an exemplary embodiment of a pan 1 in the pizza warming serve tray device for increasing the length of time the pizza stays at an optimal temperature for consumption. The pan 1 may include a bonded metal sheet 3. The bonded metal sheet 3 may be made of a bonded metal alloy including but not limited to aluminum. In one embodiment, the bonded metal alloy is 430/Aluminum/430 produced by Ametek, a manufacturer of specialty metals. The bonded alloy material is essential to the function and performance of the pan 1 as opposed to other materials. A fully stainless material is of a heavy weight and would conduct heat at too slow a rate to be considered for the present invention. Similarly, a fully aluminum material prevents utilization of a safer induction technology. The material chosen is low in weight but also increases thermal performance and induction heating compatibility.

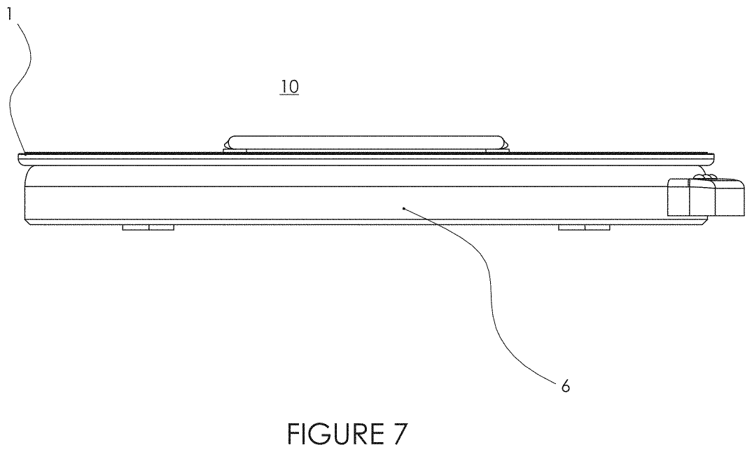

The pan 1 may include a silicone base 4. The pan 1 is coated with a molded food-grade silicone 4 to further insulate the heat contained within the pan 1 and to allow the pan 1 to be carried by hand. In some embodiments, the silicone used is an industrial grade RTV that is FDA certified for food contact and is NSF rated. In one embodiment, the silicone is RTV 102 Silicone produced by Momentive. Silicone was chosen for the present invention because it is a great thermal insulator and is safe for food and washing. Silicone prevents excess heat from escaping through the bottom of the bonded metal sheet 3. The silicone also allows for the pan 1 to be carried by bare hands when the pan 1 remains at a temperature above 200° F. In some embodiments, air pockets are designed into the silicone mold 4 to further increase thermal resistivity of the bottom of the pan as can be seen in FIG. 7.

As pizzas may be made in various sizes, in some embodiments, the size of the pan 1 may be 12-20 inches in diameter.

In some embodiments, the pan 1 includes a handle 2 attached to each side of the pan 1 at two holes 5.

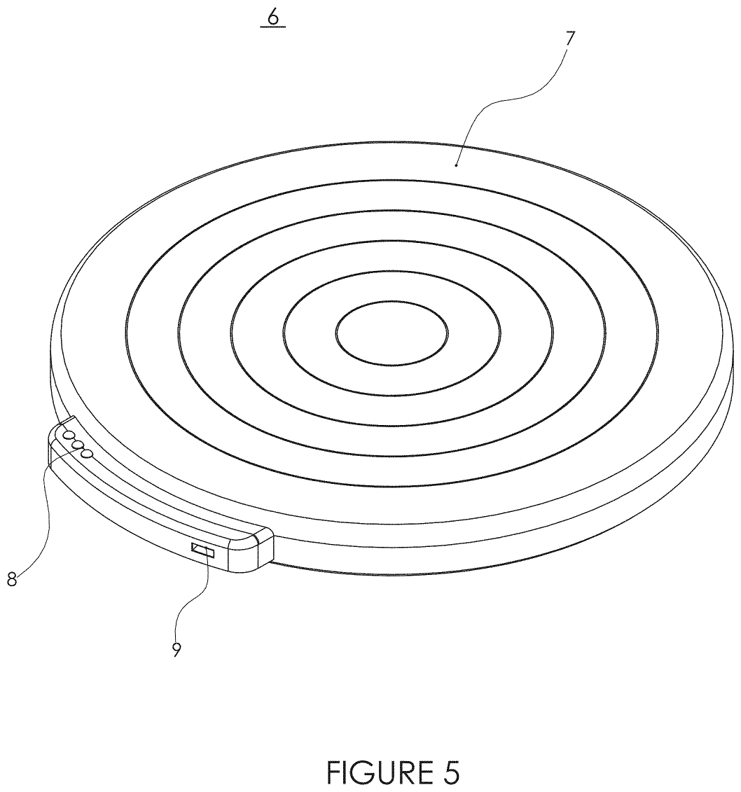

FIG. 5 illustrates an exemplary embodiment of an induction base heating unit 6 for the pizza warming serve tray device. The induction base heating unit 6 may include an interface board 9 and a housing 7. The housing 7 is a heat resistant top made of a heat resisting material including but not limited to ceramic. The induction base heating unit 6 may include indicator lights 8 on top of the interface board 9. The indicator lights 8 may be arranged in a red, yellow and green fashion. In some embodiments, when the induction base heating unit 6 is turned on, the red indicator light will emit light to indicate that there is no pan on the induction base heating unit 6. In some embodiments, the yellow indicator light will emit light to indicate that a pan is located on top of the induction base heating unit 6 and the induction base heating unit 6 is heating the pan. In some embodiments, the green indicator light will emit light to indicate that the pan located on top of the induction base heating unit 6 has reached the optimal temperature range for the pizza and may be removed for serving. In some embodiments, the optimal temperature range for the pan reached by the induction base heating unit 6 is 190-220° F.

Standard induction heating technology ranges in both effectiveness and safety. When determining the heat source for the present invention, the safest route was to use a frequency controlled design to restrict compatible materials to magnetic metals. An induction base heating unit proved to be effective.

In some embodiments, the induction base heating unit 6 may comprise an interface board 9, a housing 7, an induction coil, a printed controller board and power supply.

In some embodiments, the induction base heating unit 6 may be designed to more evenly heat the pan by expanding the size of the induction coil.

As pizzas may be made in various sizes, in some embodiments, the size of induction base heating unit 6 may be 12-20 inches in diameter. In some embodiments, the height of the induction base heating unit 6 may be 1.25-2 inches.

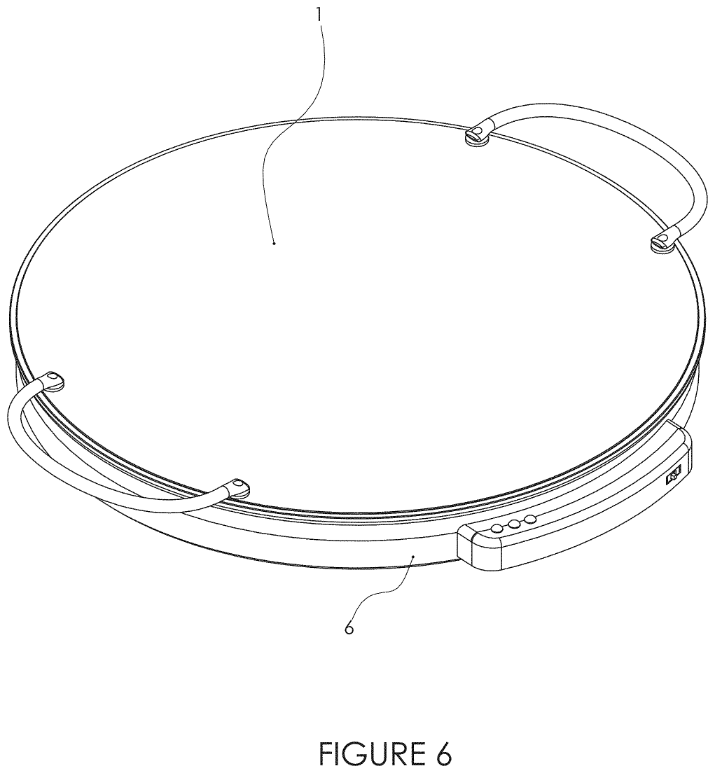

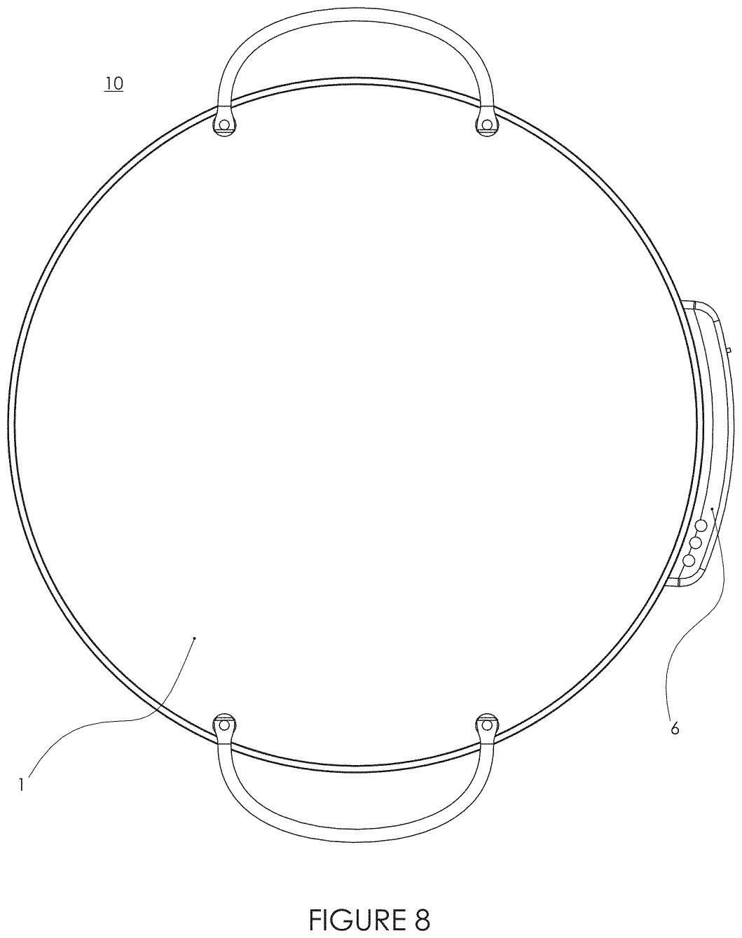

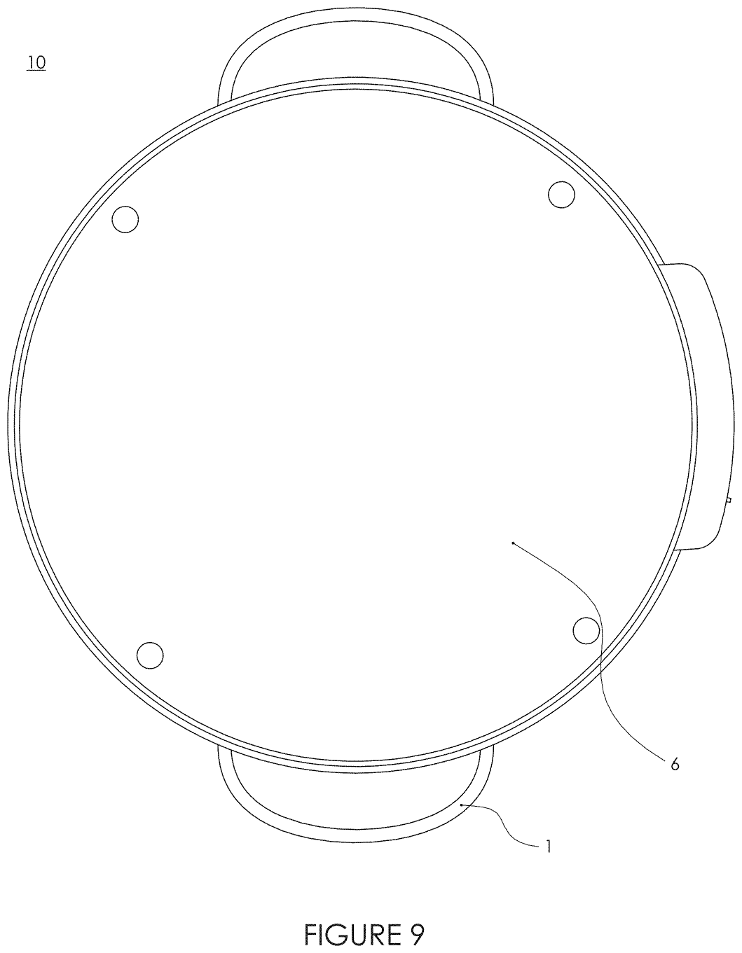

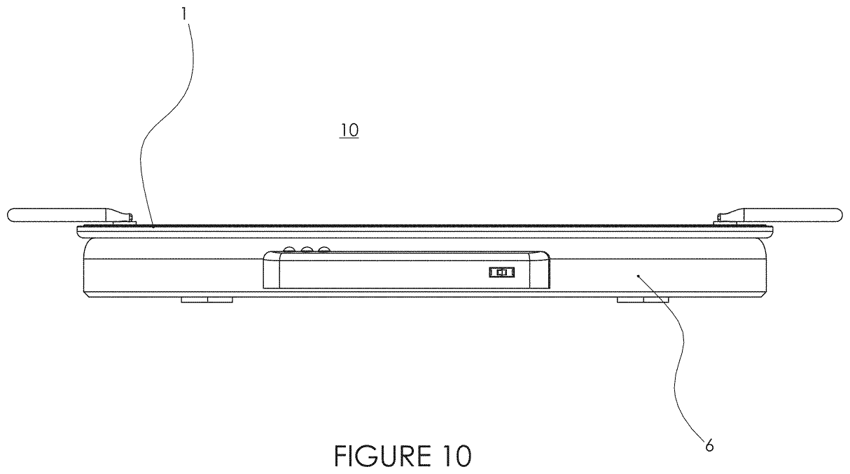

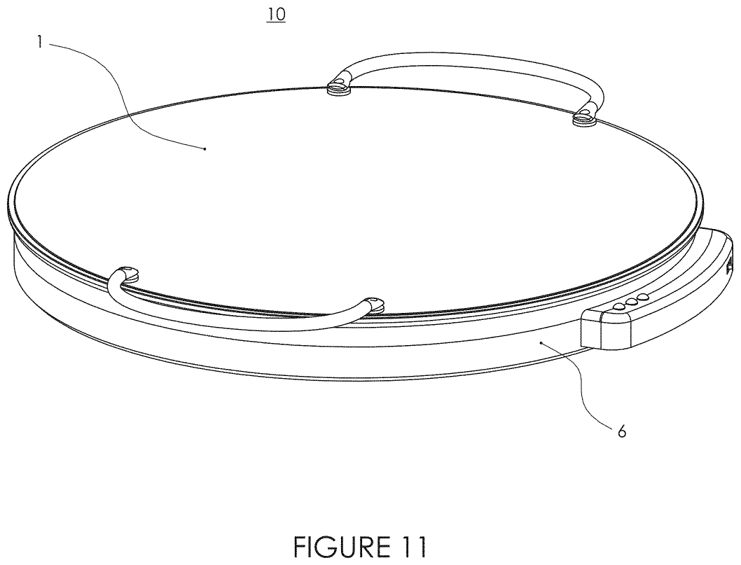

FIGS. 6-11 illustrate an exemplary embodiment of the pizza warming serve tray device 10 in operating mode comprising the pan 1 and the induction base heating unit 6.

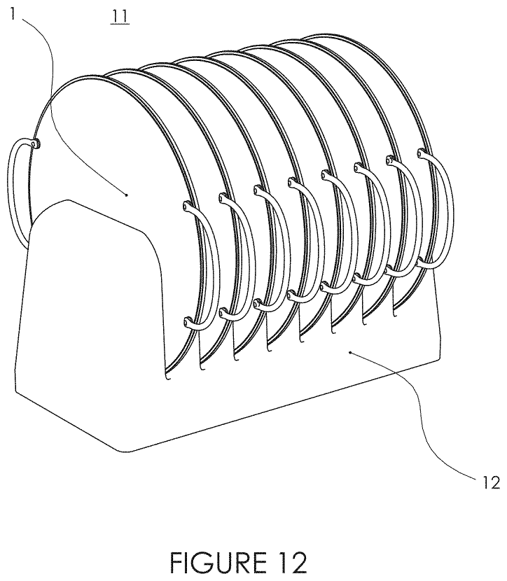

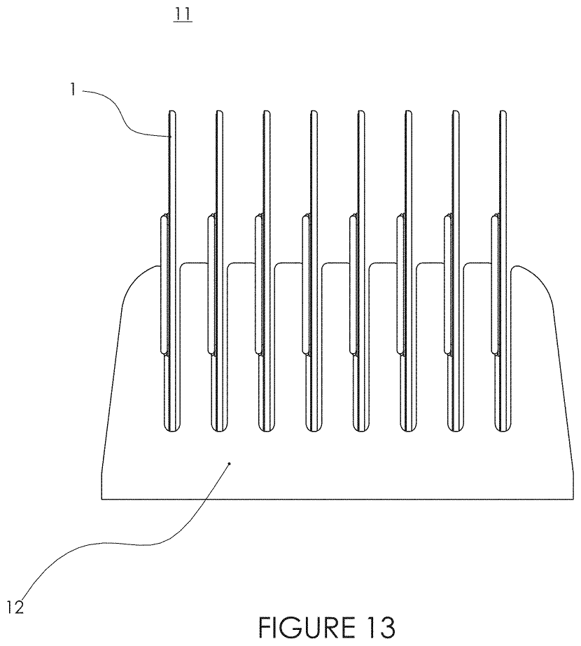

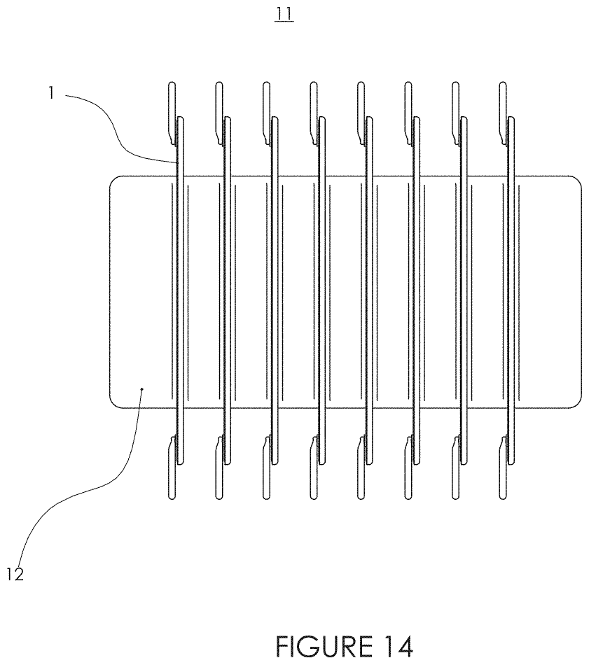

FIGS. 12-14 illustrate an exemplary embodiment of the rack 12 for holding the pans 1 for the pizza warming serve tray device. The rack 12 may hold and store multiple pans for use in the pizza warming serve tray device. The rack 12 allows for compact storage of several pans in a single location when not in use.

### EXAMPLES

Experiments were conducted on test samples of the pizza warming serve tray device to determine the key performance metrics. Experiments were conducted to determine the required heating time needed to bring the pan to the optimal temperature range of 190-220° F. and to determine the ability to maintain the temperature range while the pan remains on the induction base heating unit. The pans used in the experiments were made of 430/Aluminum/430 and were coated with RTV 102 Silicone.

### Example 1

### Examination of the Optimal Temperature Range for the Pan and the Length of Time Required to Heat the Pan

The first experiment examined the optimal initial temperature range for the pan and the length of time needed to heat the pan to the optimal range. Pizzas with an average crust temperature of approximately 190-200° F. were used. When the pan was heated, the results demonstrated that the optimal starting temperature to maximize cooling time of the pizza was 220° F. If the pan reached temperatures above 220° F., the pizza would continue to cook resulting in a change in taste or decrease in quality. Although the optimal starting temperature of 220° F. is above the average crust temperature, the design of the device is such that only the center of the pan was 220° F. and the pan remained at this temperature for only a few seconds when it comes into contact with the pizza. The heat of the pan quickly dissipated radially to a more even temperature distribution below 220° F. at approximately 190° F.

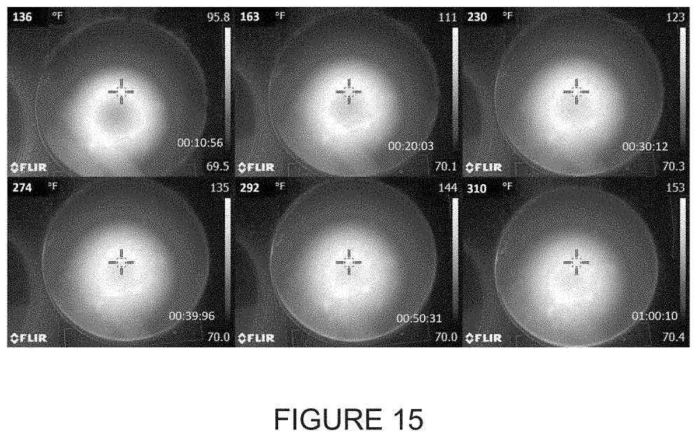

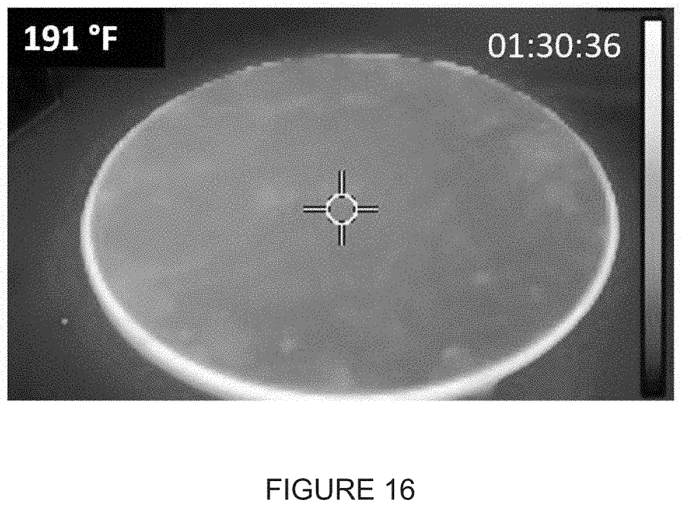

During the initial experiment, it was also discovered that the induction base heating unit can raise the temperature of the pan to 220° F. in approximately 25-30 seconds. The heating time is important to the functionality of the device in a kitchen environment to integrate into existing processes while mitigating potentially a decrease in peak output. Thus, it is an advantage for the device to have the ability to heat the pan quickly. An infrared thermal camera used during testing determined the temperature distribution of the pan when it was heated on the induction base heating unit. FIG. 15 depicts the temperature distribution of the pan on the induction base heating unit at different points over a time interval of 60 seconds. The temperature profile of the pan shows a higher temperature concentration in the center of the pan as opposed to the outer portions. FIG. 16 depicts the temperature distribution of the pan on the induction base heating unit 60 seconds after the pan reached the optimal starting temperature of 220° F. The temperature profile depicts an even distribution throughout the pan.

### Example 2

### Examination of Cooling Time

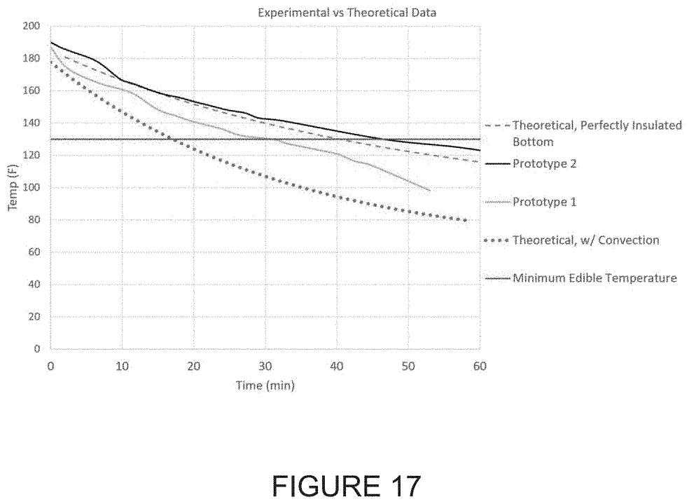

Another experiment was conducted wherein an exemplary embodiment of a pan of the present invention was compared to a standard thin aluminum pan to examine the separate cooling times of the pizza. Specifically, the experiment was designed to examine the total length of time a pizza remains in the optimal temperature range on each pan. The cooling time for three pans was examined. The first pan was a standard thin aluminum pan. The second pan was made of 430/Aluminum/430 and coated with RTV 102 Silicone, and had a thickness of 0.075 inches. The third pan was made of 430/Aluminum/430 and coated with RTV 102 Silicone, and had a thickness of 0.120 inches. The pizza samples selected for the experiment had crusts that were approximately 0.25 inches thick. The average crust temperature of the pizza when it left the oven was 190-200° F. The minimum optimal temperature for consumption was determined to be 130° F., providing the baseline for determining the length of time the device will keep the temperature of the pizza in the optimal temperature range of 130-220° F. The results demonstrated that the average cooling time of the pizza on the standard thin aluminum pan was 14-16 minutes. Specifically, it took 14-16 minutes for the pizza on the standard thin aluminum pan to drop below 130° F. By contrast, when utilizing the heated 0.075 inch pan coated in silicone the cooling time increased to approximately 30 minutes. When utilizing the heated 0.120 inch pan coated in silicone the cooling time increased to approximately 45 minutes. The results demonstrated that the pan of the present invention drastically increased the total length of time a pizza remains in the optimal temperature range. The overall increase in the total cooling time demonstrated a great advantage of the present invention over conventional pans. The results also demonstrated a correlation between the mass of the pan and the cooling time. FIG. 17 depicts a graph illustrating the data obtained during the experiment regarding cooling time for the exemplary embodiment of the pan in comparison to theoretical data.

### Example 3

### Examination of the Impact of Pizza Thickness

An experiment was conducted to determine whether the thickness of the pizza crust had an effect on the average cooling time. Generally, thick crust pizzas maintain temperature for a longer period of time than thin crust pizzas. When comparing the average cooling time of pizzas with varying crust thicknesses, the results demonstrated that the device of the present invention dramatically extended the length of time both pizzas remained in the optimal temperature range. On average, total cooling time of both pizzas was increased by 160%. These results depicted a cooling time that more than doubled the amount of time an individual may enjoy a pizza in the optimal temperature range.

The results also illustrated that cutting and removing slices of the pizza expectedly reduced the cooling time of both pizzas. Thus, the cutting and removing of the slices reduced the cooling time regardless of the thickness of the pizza.

Embodiments of the present invention have been fully described above with reference to the drawing figures. Although the invention has been described based upon these exemplary embodiments, it would be apparent to those of skill in the art that certain modifications, variations, and alternative constructions could be made to the described embodiments within the spirit and scope of the invention.

While various embodiments have been described above, it should be understood that they have been presented by way of example only, and not limitation. Thus, the breadth and scope of the present disclosure should not be limited to any of the above-described exemplary embodiments. Moreover, any combination of the above-described elements in all possible variations thereof is encompassed by the disclosure unless otherwise indicated herein or otherwise clearly contradicted by context.

1. A pizza warming serve tray device providing an increase in the length of cooling time of a pizza, the device comprising:
a pan, the pan comprising a bonded metal alloy and being coated with a molded, food-grade silicone, the silicone comprising air pockets configured to increase thermal resistivity of a bottom of the pan; and
an induction base heating unit comprising an interface board, controller board, induction coil and housing;
wherein the induction base heating unit is configured to heat the pan; and
wherein an initial temperature of the pan after heating is 190-220° F.

2. The device of claim 1, wherein the bonded metal alloy is aluminum alloy.

3. The device of claim 1, wherein said induction base heating unit is configured to heat the pan to 190-220° F. in 25-30 seconds.

4. The device of claim 1, wherein the pan has a thickness of 0.050-0.120 inches.

5. (canceled)

6. The device of claim 1, wherein said interface board of said induction base heating unit comprises indicator lights for indicating when the pan is being heated.

7. The device of claim 1, wherein said device is configured to increase the length of time a pizza remains at a temperature above 130° F.

8. The device of claim 7, wherein the length of time the pizza remains at a temperature above 130° F. is 30-45 minutes.

9. (canceled)

10. The device of claim 1, wherein the silicone is an industrial grade room-temperature-vulcanizing (RTV) silicone.

11. The device of claim 1, wherein the induction base heating unit is 12-20 inches in diameter.

12. The device of claim 1, wherein the induction base heating unit is 1.25-2 inches in height.

13. The device of claim 1, wherein the housing comprises a heat-resistant top.

14. The device of claim 13, wherein the heat-resistant top comprises a ceramic material.

15. The device of claim 6, wherein one of the indicator lights indicates that an optimal temperature range of 190-220° F. for the pan has been reached.

16. A rack for use in conjunction with the pizza warming serve tray devices of claim 1, wherein the rack is configured to hold a plurality of pans.

17. (canceled)

18. A method of operation of a pizza warming serve tray device, wherein the device comprises:
a pan, the pan being composed of a bonded metal alloy and being coated with a molded, food-grade silicone, the silicone comprising air pockets configured to increase thermal resistivity of the bottom of the pan; and
an induction base heating unit comprising an interface board, controller board, induction coil and housing,
the method comprising the steps of:
heating the pan to a temperature in the range of 190-220° F.; and
using an upper surface of the pan to contact a pizza,
to change a cooling time of the pizza.

19. The method of claim 18, wherein the device is configured to increase the length of time the pizza stays at a temperature for consumption in the range of 130-220° F.

20. The method of claim 19, wherein the pizza remains at a temperature above 130° F. for a period of 30-45 minutes.
